(19) United States
(12) Patent Application Publication
(10) Pub. No.: US 2022/0125215 A1
(43) Pub. Date: Apr. 28, 2022

(54) Orthopedic Mattress Topper System and Method

(71) Applicant: Pedigree Systems Inc., Sevierville, TN (US)

(72) Inventors: Mark V. Jackson, Sevierville, TN (US); Jeffrey L. Jones, Sevierville, TN (US)

(21) Appl. No.: 17/355,625

(22) Filed: Jun. 23, 2021

Related U.S. Application Data
(60) Provisional application No. 63/105,941, filed on Oct. 27, 2020.

(51) Int. Cl. A47C 27/08; A47C 27/18

(52) U.S. Cl. CPC A47C 27/083; A47C 27/18; A47C 27/084; A47C 27/082

(57) ABSTRACT

A mattress topper system, and a method of controlling the system, including an upper sheet and a lower sheet coupled together so as to define an interior volume divided into a plurality of zones, each of the zones having a plurality of cells of which adjacent cells are in fluid communication with one another inside the respective zones, and at least one air pump configured to regulate pressure in the cells of each respective zone such that the pressure in at least a first one of the zones is different from the pressure in at least a second one of the zones.

### CROSS-REFERENCE TO RELATED APPLICATIONS

This application claims the benefit of U.S. Provisional Patent Application Ser. No. 63/105,941, filed on Oct. 27, 2020, which is incorporated herein in its entirety by reference.

### FIELD OF INVENTION

The present general inventive concept relates to an orthopedic mattress topper, and, more particularly, to an orthopedic mattress topper which helps prevent the formation of bed sores on the body of a patient resting upon the mattress topper.

### BACKGROUND

Hospitals, nursing homes, and families have long endured a thankless task of trying to ensure a bedridden family member or patient does not succumb to bed sores or skin ulcers. Such sores/ulcers develop, according to experts, due to the thinning of the skin with age, lack of movement, and constant contact (due to lack of movement) with the surface of the bed on which they lie, or a wheel chair seat, and so on. In some cases bedridden or other such immobilized people may not move for hours on end, which means that a surface of a specific portion of the body, such as the heel of the foot or the buttocks, is in constant contact, and near constant pressure, with whatever resting surface that portion of the body is lying against. The constant pressure on that one point can prevent the flow of blood in the region of contact. If blood flow is cut off for more than a few hours, the skin dies, beginning with its outer layer (the epidermis). The dead skin breaks down and an open sore (ulcer) develops. Most people do not develop pressure sores because they constantly shift positions without thinking, even when they are sleep. However, with people that are immobilized for any of a number of medical reasons, there may be long periods of no change in resting position without some sort of intervention by family or medical support staff. The population is currently generating the largest group of “seniors” that has ever existed, and at a time when health care costs are a disproportionate part of most any budget. While more seniors will choose to stay in their own homes as long as possible, others will eventually be placed in private health facilities, and still others will eventually be placed in public facilities. Simply due to the large number of seniors entering retirement years, it is easy to extrapolate that there a number of those seniors that will need a different type of bedding than typically provided, and which requires so much supervision and/or intervention to avoid these discussed medical problems.

Therefore, it would be desirable to have a way of aiding immobilized persons to not develop such bed sores by providing or prompting the types of movement that non-immobilized persons make during periods of rest.

### BRIEF SUMMARY

According to various example embodiments of the present general inventive concept, a mattress topper is provided to help aid in the prevention of bed sores and similar maladies associated with being bedridden. Mattress toppers according to the present general inventive concept may be configured with a plurality of zones having cells or bladders configured such that the different zones are filled and emptied to desired pressure levels at periodic intervals so as to simulate pressure variations of physical movement by a patient using the mattress topper.

Additional aspects and advantages of the present general inventive concept will be set forth in part in the description which follows, and, in part, will be obvious from the description, or may be learned by practice of the present general inventive concept.

The foregoing and/or other aspects and advantages of the present general inventive concept may be achieved by providing a mattress topper system including an upper sheet and a lower sheet coupled together so as to define an interior volume divided into a plurality of zones, each of the zones having a plurality of cells of which adjacent cells are in fluid communication with one another inside the respective zones, and at least one air pump configured to regulate pressure in the cells of each respective zone such that the pressure in at least a first one of the zones is different from the pressure in at least a second one of the zones.

The foregoing and/or other aspects and advantages of the present general inventive concept may also be achieved by providing a mattress topper system in which the at least one air pump is configured to periodically change the pressure in the cells of each respective zone. Various example embodiments of the present general inventive concept may be achieved by providing a mattress topper system in which the at least one air pump is configured to maintain the pressure in the cells of each respective zone for a predetermined interval of time. Certain embodiments may be achieved in which the at least one air pump is configured to regulate the pressure in the cells such that no two adjacent zones has the same pressure for the predetermined interval of time. In certain example embodiments, the at least one air pump may be configured to raise or lower the pressure in the cells of each respective zone at predetermined intervals of time. In certain example embodiments, the at least one air pump may be a multi-output configured with a plurality of air hoses respectively coupled to the respective zones. In certain example embodiments, the at least one air pump may comprise a controller configured to control the at least one air pump to periodically adjust the pressure in the cells of the respective zones. In certain example embodiments, the upper and lower sheets may be coupled together so as to form a plurality of zones in each of a lengthwise and lateral directions. In certain example embodiments, the upper and lower sheets may be coupled together so as to form at least two zones in the lengthwise direction, and at least three zones in the lateral direction, such that six zones are formed having the plurality of cells in each of the six zones. In certain example embodiments, the zones may have substantially same dimensions. In certain example embodiments, the system may further comprise an equalization sheet provided over the upper sheet. In certain example embodiments, the system may further comprise a foam layer provided over the upper sheet.

The foregoing and/or other aspects and advantages of the present general inventive concept may be achieved by providing a method of regulating pressure in a mattress topper to provide movement to a patient resting thereon. Various example embodiments of the present general inventive concept may be achieved by providing a mattress topper that is partitioned into a plurality of zones in both lengthwise and lateral directions, each of the zones having a plurality of cells configured to be in fluid communication with one another inside those respective zones. Various example embodiments of the present general inventive concept may be achieved by providing at least one air pump to regulate pressure in the cells of each respective zone. Various example embodiments of the present general inventive concept may be achieved by controlling the at least one air pump to periodically change the pressure in the respective zones at predetermined or random intervals of time.

In certain example embodiments, the periodically changing the pressure may comprise raising the pressure in at least a first one of the zones, and lowering the pressure in at least a second one of the zones. In certain example embodiments, the periodically changing the pressure may comprise preventing any adjacent ones of the zones from having the same pressure during the intervals of time. In certain example embodiments, the periodically changing the pressure may comprise changing the pressure in all of the zones at a same time. In certain example embodiments, the intervals of time may be five, ten, or fifteen minutes. In certain example embodiments, the periodically changing the pressure may comprise not repeating the pressure in any given zone for at least a predetermined number of the intervals of time. In certain example embodiments, the periodically changing the pressure may comprise programming a range of pressures to be applied to each respective zone.

The foregoing and/or other aspects and advantages of the present general inventive concept may be achieved by providing a mattress topper to provide movement to a patient resting thereon, the mattress topper comprising an upper sheet and a lower sheet coupled together so as to define an interior volume comprising a plurality of zones in both lengthwise and lateral directions, and a plurality of cells configured such that adjacent cells in each respective zone are in fluid communication with one another, a fluid hose coupling provided to each respective zone.

Other features and aspects may be apparent from the following detailed description, the drawings, and the claims.

### BRIEF DESCRIPTION OF THE FIGURES

The following example embodiments are representative of example techniques and structures designed to carry out the objects of the present general inventive concept, but the present general inventive concept is not limited to these example embodiments. In the accompanying drawings and illustrations, the sizes and relative sizes, shapes, and qualities of lines, entities, and regions may be exaggerated for clarity. A wide variety of additional embodiments will be more readily understood and appreciated through the following detailed description of the example embodiments, with reference to the accompanying drawings in which:

FIG. 1 illustrates a perspective view of a mattress topper according to an example embodiment of the present general inventive concept;

FIG. 2 illustrates a top view of an example die or mold which may be used in the fabrication of the mattress topper of FIG. 1 according to an example embodiment of the present general inventive concept;

FIG. 3 illustrates a top view of the mattress topper of FIG. 1 along with pressure regulating components according to an example embodiment of the present general inventive concept;

FIG. 4 illustrates a section view of the mattress topper system of FIG. 3;

FIG. 5 illustrates a section view a mattress topper system according to another example embodiment of the present general inventive concept;

FIG. 6 illustrates a section view of a mattress topper system according to still another example embodiment of the present general inventive concept; and

FIG. 7 is a flow chart illustrating a method of controlling pressure in a multi-zone mattress topper system according to an example embodiment of the present general inventive concept.

### DETAILED DESCRIPTION

Reference will now be made to the example embodiments of the present general inventive concept, examples of which are illustrated in the accompanying drawings and illustrations. The example embodiments are described herein in order to explain the present general inventive concept by referring to the figures.

The following detailed description is provided to assist the reader in gaining a comprehensive understanding of the structures and fabrication techniques described herein. Accordingly, various changes, modification, and equivalents of the structures and fabrication techniques described herein will be suggested to those of ordinary skill in the art. The progression of fabrication operations described are merely examples, however, and the sequence type of operations is not limited to that set forth herein and may be changed as is known in the art, with the exception of operations necessarily occurring in a certain order. Also, description of well-known functions and constructions may be simplified and/or omitted for increased clarity and conciseness.

Note that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. Spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

According to various example embodiments of the present general inventive concept, a mattress topper or mattress topper system is provided to help aid in the prevention of bed sores and similar maladies associated with being bedridden. Mattress toppers according to the present general inventive concept may be configured with a plurality of zones each having air bladders configured such that the bladders in different zones are filled and emptied to desired fill levels at periodic intervals so as to simulate pressure variations of physical movement by a patient using the mattress topper. In the descriptions herein the air bladders may be referred to by cells, indicating the cell structure of the bladders. By controlling the flow of air into and out of cells in the respective zones, different air pressures are maintained in the zones. Thus, by periodically changing the pressure in the respective zones either up or down, the pressure on the parts of a bedridden patient's body is varied, which helps in preventing bedsores. This action can simulate, or at least approximate, the kind of pressure changes that occur when a healthy sleeper moves, turns, etc., during the night. One or more air pumps connected to the cells can be programmed to control the increases and reductions in air pressure in the zones. For example, the pressure may be changed, up and/or down, every five minutes, every ten minutes, every fifteen minutes, and so on.

Various example embodiments of the present general inventive concept, as described herein, provide a mattress topper or similar support structure in which two sheets or panels (hereinafter referred to as “sheets”) define an interior volume, the interior volume being divided into a plurality of the aforementioned zones, and the zones being further subdivided into a plurality of cells, with adjacent cells within the respective zones being in fluid communication with one another. The division of the interior volume into zones, and the subdivision of the interior volume of the zones into cells, may be achieved by coupling the two sheets together at predetermined points and/or lines through any general technique of bonding. This may be done through a number of different techniques, such as spot welds connecting the upper sheet and the lower sheet, using an applied adhesive agent, or the like, or any combination thereof. In the example embodiments described herein, the coupling of the upper and lower sheets is generally described as involving the spot welding technique, though it is understood that other coupling methods may be substituted or use in combination.

Any of a number of predetermined geometric shapes may be provided for the cells, according to the chosen fabrication process and/or configuration. In most of the example embodiments described herein, a hexagonal shape is described. However, it is understood that a host of other geometric shapes may be provided, such as, for example, triangles, various parallelograms, and so on. Also, different combinations of these geometric patterns may be present in the same bed. Further, these geometric shapes are not limited to the exact shapes described. For instance, a pattern referred to as square may be a substantially square four-sided pattern, and so on. Although the various example embodiments described herein generally discuss a mattress topper, it is understood that the zoned inflatable cell system could also be integrated with an underlying mattress. Also, the size of the described mattress topper may vary according to different bed sizes, to provide more therapeutic comfort for a variety of patient sizes.

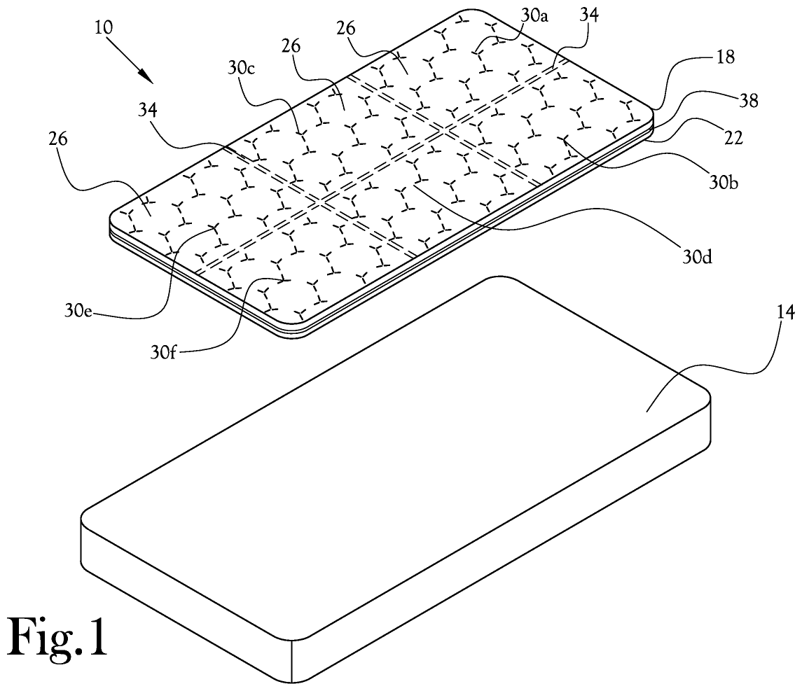

FIG. 1 illustrates a perspective view of a mattress topper according to an example embodiment of the present general inventive concept. In the example embodiment illustrated in FIG. 1, a mattress topper 10 is shown with a typical mattress 14 over which the mattress topper 10 may be laid to help a bedridden patient avoid bedsores. The mattress topper 10 of FIG. 1 is shown without the pump and hose connections that are described herein simply to easily illustrate the mattress topper 10 itself. While the mattress 14 illustrated in FIG. 1 generally has the dimensions of a typical hospital bed, and the mattress topper 10 is shown with a length and width similar to the mattress 14, it will be understood that the mattress topper 10 may have a variety of different dimensions, that either correspond to a mattress size or not, without departing from the scope of the present general inventive concept. For example, the mattress topper 10 may be smaller or larger in length and/or width than a mattress upon which it is used, and still provide the therapeutic benefit to the patient resting thereon. The illustrated mattress topper 10 includes an upper sheet 18 and a lower sheet 22 that are bonded together so as to form a plurality of cells 26 that are themselves divided into a plurality of zones 30 in the mattress topper 10. The zones 30 are divided by a plurality of partitions, dividers, or borders 34 such that a plurality of zones 30 are formed both in a lateral direction, or from side to side of the mattress topper 10, and a longitudinal direction, or from end to end of the mattress topper 10. In the example embodiment illustrated in FIG. 1, there are six zones 30a-30f formed in the mattress topper 10, generally in two columns of three rows, though various other example embodiments may include fewer or more zones, and in a host of different configurations. The borders 34 forming the zones 30 may be formed by bonding the upper sheet 18 and the lower sheet 22 together in the same manner as the forming of the cells 26. In other various example embodiments the borders 34 may be formed in a different manner, such as adhesives, or may be formed with solid members that are arranged between, and bonded to both, the upper sheet 18 and lower sheet 22. Thus, while adjacent cells 26 within the respective zones 30 are configured to be in fluid communication with one another so as to at least somewhat equalize the fluid pressure within a particular zone 30, there is no fluid communication between cells 26 of different zones 30. As such, different pressures can be applied to the cells 26 within the respective zones 30. The example embodiment illustrated in FIG. 1 includes a perimeter banding 38 to which both the upper sheet 18 and lower sheet 22 are bonded, or otherwise coupled, at the perimeter of each sheet. In other various example embodiments, the upper sheet 18 and lower sheet 22 may be perimetrically coupled directly to one another.

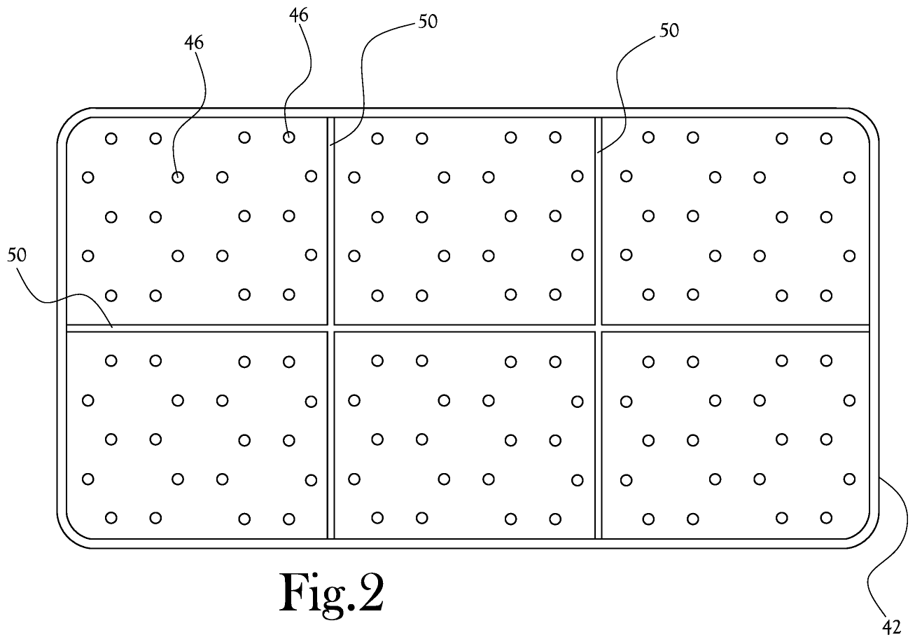

FIG. 2 illustrates a top view of an example die or mold which may be used in the fabrication of the mattress topper 10 of FIG. 1 according to an example embodiment of the present general inventive concept. As illustrated in FIG. 2, the die 42 includes a plurality of pegs 46 configured in a repeating hexagonal pattern that forms the hexagonal cells 26 illustrated in FIG. 1, and a plurality of border structures 50 that form the borders 34, and therefore the zones 30, illustrated in FIG. 1. During the fabrication process, the pegs 46 provide the foci where spot welds are formed to couple the upper sheet 18 and the lower sheet 22. Similarly, the upper sheet 18 and lower sheet 22 are welded together along the entirety of the border structures 50 to separate the zones 30 of the mattress topper 10. In the illustrated example embodiment of the die 42, the pegs 46 are positioned and configured within the zones 30 formed by the borders 34 so that the spot welds, when formed, are positioned so that they form hexagonal cells that are in fluid communication with each other within the respective zones 30, such that the hexagonal cells comprise a hexagonal tessellation. In other various example embodiments, the pegs may be positioned so that the spot welds are configured so that they form substantially triangular cells, substantially square cells, etc., that are in fluid communication with each other within each of the zones. Similarly, while the mattress topper 10 formed on the die 42 of FIG. 2 has six zones 30 of cells 26, it is understood that various example embodiments may have a host of differently configured zones, and may include more or fewer zones than six. For example, a mattress topper may have 10 zones that are angled relative to the longitudinal axis of the mattress topper, or 8 zones that have curved borders, and so on. The six zones 30 illustrated in the mattress topper 10 may provide good coverage for an average sized patient that is situated to lie along the middle of the bed, thus having six zones of varying pressure to provide at least some modicum of movement of the patients contacting body parts.

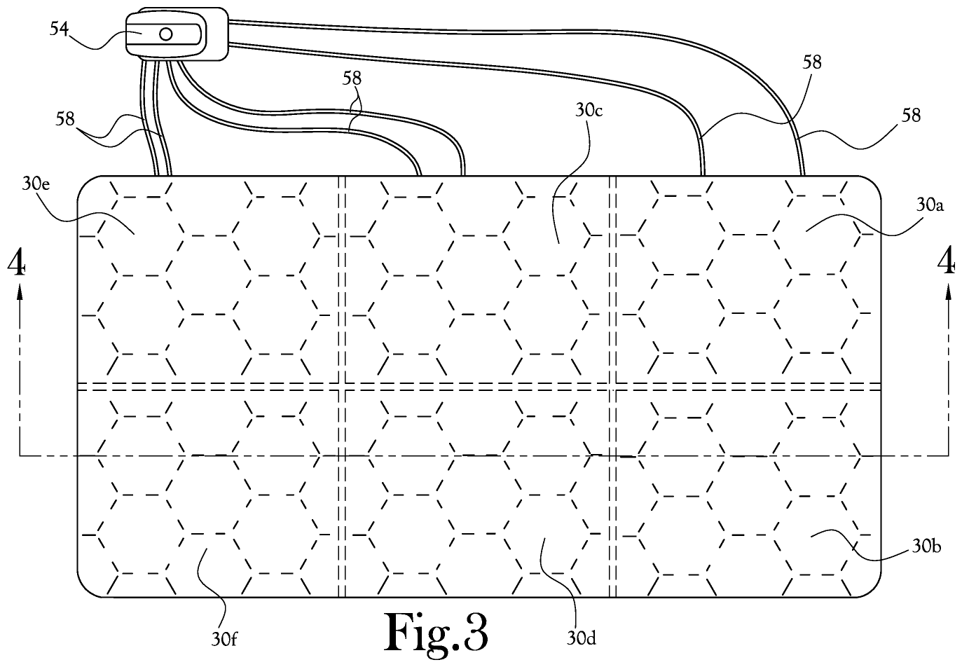

FIG. 3 illustrates a top view of the mattress topper 10 of FIG. 1, and formed on the die 42 of FIG. 2, along with pressure regulating components according to an example embodiment of the present general inventive concept. The mattress topper 10 is provided with a multiple output air pump 54 to supply air and regulate the pressure in the cells of each of the zones 30 individually, forming a mattress topper system that allows different and variable pressures in each of the zones 30 to help prevent a bedridden patient resting on the mattress topper 10 from developing bedsores. The air pump 54 is configured with a plurality of air supply hoses 58 that are connected to each of the respective zones 30 so that the pressure in each zone 30 can be individually controlled. It will be understood that the positioning and configuration of the pump 54 and hoses 58 illustrated in FIG. 3 is presented for clarity and easy understanding of the present general inventive concept, as in various example embodiments the hoses 58 may be bundled together at a point at which they pass under the mattress topper 10 for a more appealing appearance. In various example embodiments the hoses 58 may be connected to the respective zones on an underside of the mattress topper 10, or at sides of the zones 30, or a combination of such various positions. While the example embodiment of FIG. 3 is described in terms of an air pump regulating air pressure in the mattress topper 10, various example embodiments may provide a pump to regulate pressure for other types of fluids than air without departing from the scope of the present general inventive concept. The air pump 54 is configured to supply air through the hoses 58 in an individual manner to each of the zones 30 of the mattress topper 10, and to regulate the pressure in the cells 26 of each zone 30 independently from the pressure of the other zones 30. For example, each of zones 30a-30f may be initially pressurized to a desired starting pressure whereas the highest desired pressure is set in the cells 26 of zone 30a, a lower pressure is set in zone 30d, a lower pressure than zone 30d is set in zone 30e, a lower pressure than zone 30e is set in zone 30f, and so on. Then, at desired intervals, the air pump 54 may adjust the cells 26 in each of the respective zones 30 to be at a higher or lower level of pressure so as to vary the pressure against different areas of the patient's body. The air pump 54 may be provided with a processor or controller, having onboard or separately configured memory, through which a stored machine-readable code may control the air pump 54 to variably regulate the pressures in the zones 30 in this manner. A time interval of, for example, 5, 10, or 15 minutes may be programmed to control the time between changes in pressure in the zones 30. In various example embodiments, the air pump 54 may be controlled to randomly change the pressures in the cells 26 of each of the zones 30 either up or down to simulate normal movement of the patient's body through true physical transition/movement every programmed interval. In other various example embodiments, the actual changes in pressure of the zones 30 may be programmed to a user's preferences, so that an order of changes in pressure may be followed. In various example embodiments the air pump, which may be configured with air pressure sensors for each of the pump's multiple output valves to regulate the individual zones' 30 pressures, may be programmed such that no two zones 30 have the same pressure at the same time. In various example embodiments the intervals between pressure changes may be randomized in a range between a longest and shortest possible desired time interval. In various example embodiments only a subset, or one, of the zones 30 will have the pressure therein varied at one time, to provide even more random “movement” of the mattress topper 10. As will be understood, the periodic pressurizing and decompression of the cells 26 in the individual zones 30 can provide some movement under the bedridden patient that will approximate the natural movements of a typical sleeper. In various example embodiments the pump 54 may have a graphical interface through which the variable pressure control may be programmed and/or adjusted. In various example embodiments the pump 54 may be configured to electronically communicate with a wired or wireless processing device through which a user may program, adjust, or otherwise control the pump 54. For example, the periodic pressurizing and decompression of the zones 30 may be controlled through a smartphone or similar device communicating with and/or controlling the pump 54. In various example embodiments a plurality of air pumps may be configured to regulate the pressure in the zones. For example, in one example embodiment a first pump could be configured to regulate the pressure in half of the zones, and a second pump could be configured to regulate the pressure in the other half of the zones. In such an example embodiment, the pumps may be configured to be in electrical communication with each other, of in electrical communication with another processing device that coordinates the operations of the multiple pumps.

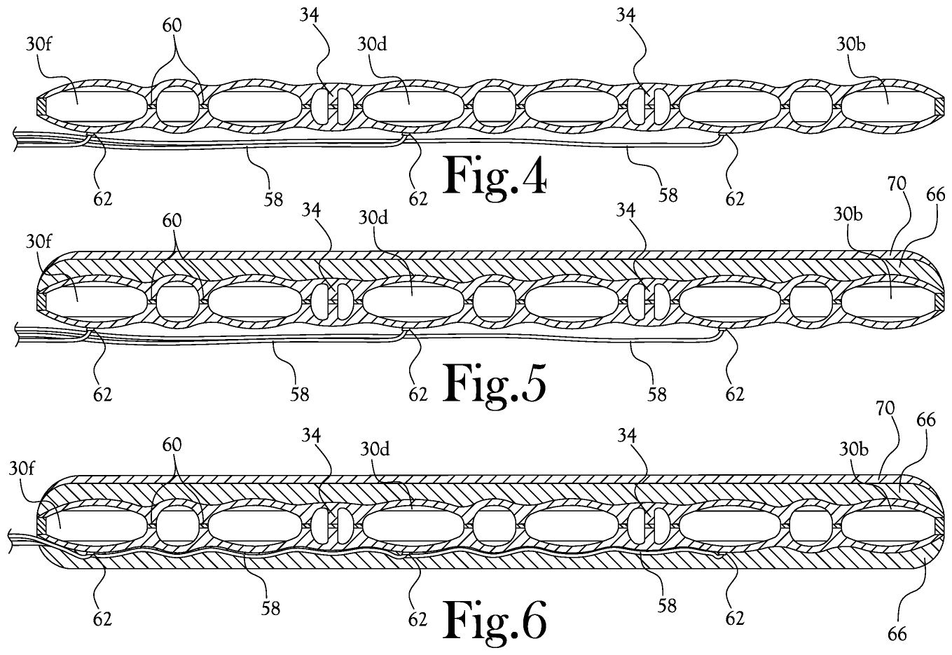

FIG. 4 illustrates a section view of the mattress topper system of FIG. 3, the section view taken along the section line illustrated in FIG. 3. As illustrated in the sectional view of FIG. 4, within the interior volume defined by the upper sheet 18, the lower sheet 22, and the perimeter banding 38, a number of spot welds 60 connect the upper sheet 18 to the lower sheet 22. Cells 26 are defined by the regions between spot welds 60 formed corresponding to the pegs 46 of the die 42, and the zone 30 borders 34 may be formed by similar spot welds made along the border structures 50 of the die 42. As previously discussed, in various example embodiments the spot welds 60 may be positioned so that they form the hexagonal cells 26 that are in fluid communication with each other within the respective zones 30, such that the hexagonal cells 26 comprise a hexagonal tessellation H, as illustrated in FIG. 3. In other various example embodiments, the spot welds may be configured so that they form other shapes, such as substantially triangular or parallelogrammatic cells that are in fluid communication with each other within the zones. The cells 26 may be structured, and the pressure in the cells 26 may be controlled, such that, no matter how decompressed, no individual cell 26 will be compressed to the point at which the upper sheet 18 contacts the lower sheet 22 within the cell area between the spot welds 60. Though the example embodiments of the mattress topper 10 and system have been described herein as involving air as the regulated fluid in the cells 26, it is understood that the term “fluid” in various example embodiments could refer to air, gels, and other fluids, such as liquid fillers or water-based solutions. When fully assembled, the cells 26 of the mattress topper 10 could be filled with any of these fluids, or any combination thereof, and various types of pumps may be employed to regulate the pressure of those fluids in the cells 26.

Mattress topper 10 stiffness generally is a function of the physical size and shape of the individual cells as well as the thickness of the sheets. In various example embodiments of the present general inventive concept, the upper sheet 18 and/or the lower sheet 22 may be fabricated from polyurethane. In various example embodiments, the upper sheet 18 and/or the lower sheet 22 may be fabricated from polyethylene. In various example embodiments, the upper sheet 18 and/or the lower sheet 22 may be fabricated from a polyvinyl material (such as polyvinyl chloride) or a similar polymer or blends thereof. In various example embodiments, the upper sheet 18 and/or the lower sheet 22 may be fabricated from a mixture of polymers. In various example embodiments, the upper sheet 18 and/or the lower sheet 22 may be fabricated from a blend of polyurethane and a polyvinyl material. In various example embodiments, the upper sheet 18 and/or the lower sheet 22 may be fabricated from other materials. In various example embodiments, the downward (or exterior) face of the lower sheet 22 may be textured or patterned so that it will inhibit horizontal movement of the mattress topper 10 on the mattress 14. In various example embodiments of the present general inventive concept, the upper sheet 18 and the lower sheet 22 may both be fabricated from a polyurethane-based material, and each sheet may be approximately 15 mil thick. The spot welds 60, which may be positioned and configured to form a tessellation pattern of hexagonal cells, may be formed on pegs that are substantially circular or cylindrical and that may be approximately ⅛ to ½ inch in diameter and ¼ inch in height. In various example embodiments the mattress topper 10 may be approximately 80 inches long and 34 inches wide. The example embodiment illustrated in FIGS. 3-4 shows a mattress topper 10 with six zones 30 of influence, but a host of other configurations may be possible without departing from the scope of the present general inventive concept. Those of skill in the art will recognize that the present general inventive concept encompasses numerous other potential sizes, dimensions, and configurations.

As illustrated in FIG. 4, the mattress topper 10 is configured with a plurality of hose fittings 62 configured to be connected to the air hoses 58 so that the air pressure in the cells 26 can be regulated. One hose fitting 62 will be provided to each respective zone 30, so that the multi-output pump 54 can individually control the pressure in the cells 26 of those respective zones 30. For the sake of clarity, only the hose fittings 62 which are provided to zones 30b, 30d, and 30f are illustrated in FIG. 4, but it is understood that such hose fittings 62 are also provided to zones 30a, 30c, and 30f. Once the air hoses 58 are connected between the air pump 54 and the respective hose fittings 62, the pump can control the pressure of the zones 30 in the desired manner. In various example embodiments a pump may be used that has fewer outputs than the zones provided in the mattress topper, and one or more of the hoses attached to such a pump may be configured to branch into two or more sections to be fitted to the hose fittings of the mattress topper. In such an example embodiment the different branches of any single hose may be connected to non-adjacent zones, so that no two adjacent zones would have the same pressure during the programmed time intervals. The hose fittings 62 may be configured in a host of ways, such as, for example, push button connectors, threaded connectors, and so on, and mating connectors may be provided at distal ends of the hoses 58. Further, although the fittings 62 are illustrated in FIG. 4 as extending downward to provide access to the hoses 58, this is simply for the sake of simplicity in illustration, and such fittings 62 may be provided in a host of different configurations and/or locations on the mattress topper 10. For example, the fittings 62 may be located proximate the sides of the mattress topper 10, or may be concealed under another layer of material such as foam, and so on.

FIG. 5 illustrates a section view a mattress topper system according to another example embodiment of the present general inventive concept. In the example embodiments of FIG. 5, a foam layer 66 has been provided so as to cover a top layer of the mattress topper 10, and an equalization sheet 70 has been provided so as to cover the foam layer 66. Such layers of material may provide more comfort to the patient, and help prevent the patient from feeling any uneven surface provided by the cell structure in the zones 30. FIG. 6 illustrates a section view of a mattress topper system according to still another example embodiment of the present general inventive concept, in which another foam layer 66 is provided on the bottom surface of the mattress topper 10. In such example embodiments the hose fittings 62 may be configured at the sides of the mattress topper, at the edge of the bottom foam layer, or may be configured to reach through the foam layer to be accessible for connection to the hoses 58. Various example embodiments may provide different configurations of these additional layers of materials. For example, example embodiments may include just the equalization sheet 70 in lieu of a foam layer in between, or the equalization sheet 70 located between the mattress topper 10 and the foam layer 66. In example various embodiments the mattress topper and one or more foam or other such sheets/pads may be surrounded by an outer cover, such as a pillow or a fabric bag, that contains the mattress topper and the one or more additional material layers. The outer cover may aid in keeping the components together when the combined structure is in use, and may be separately removed and washed apart from the mattress topper and the one or more comfort/equalization sheets or pads. A moisture resistant inner cover may be provided inside the removable and washable outer cover.

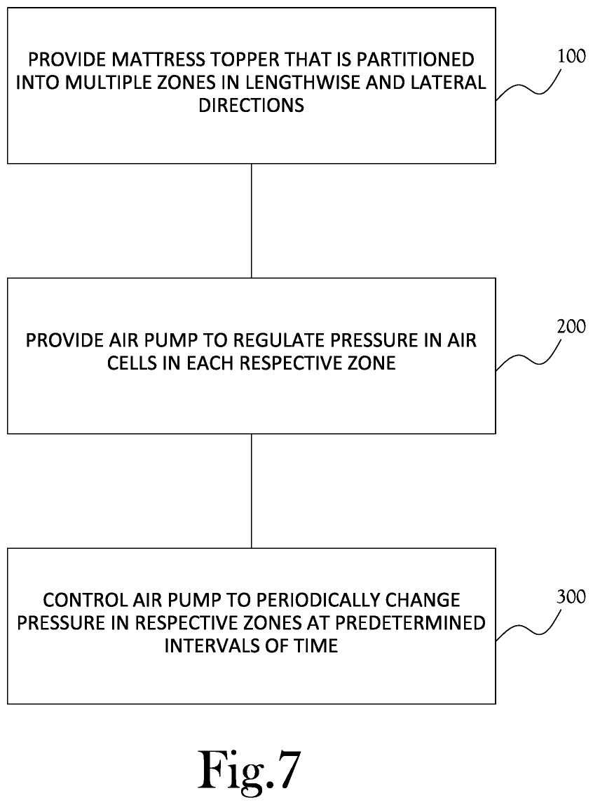

FIG. 7 is a flow chart illustrating a method of controlling pressure in a multi-zone mattress topper system according to an example embodiment of the present general inventive concept. As illustrated in FIG. 7, in operation 100 a mattress topper is provided and arranged on a mattress or other bedding, the mattress topper being partitioned into multiple zones in both lengthwise and lateral directions. For example, the mattress topper illustrated in FIG. 1 has two zone borders in the lateral direction, and one zone border in the lengthwise direction (not counting the perimeter of the device), for a total of six zones. In operation 200 an air pump is provided to regulate presser in the air cells of each respective zone. In operation 300 the air pump is controlled to periodically change the pressure in the respective zones at predetermined intervals of time. For example, every 5 or 10 or 15 minutes the air pressure is raised or lowered in each of the respective zones to provide movement to the bedridden patient resting thereon, simulating some of the regular movement of a typical sleeper. In various example embodiments the air pump may be controlled such that no two adjacent zones has the same pressure, or any pressure won't be repeated in any given zone for a predetermined number of intervals, and so on.

According to various example embodiments of the present general inventive concept, an overlay referred to herein as a mattress topper is configured to aid the invalid and bedridden. Example embodiments of this device may be purchased and installed on top of any existing mattress. Example embodiments of the present general inventive concept may include a quiet air pump with a proprietary program that supplies pressure into the cells, or bladders, of the mattress. In various example embodiments the zones, into which the mattress topper has been partitioned by either bonding of top and bottom sheets or by border inserts between the top and bottom sheets, are pressurized or decompressed in different sequences to provide movement to relieve “pressure points.” While there is no substitute for an individual's actual physical movement, the mattress topper of the present general inventive concept allows for true physical transition/movement, for example, every 5, 10, or 15 minutes, or whatever interval may be programmed into the pump. In various example embodiments different zones may be programmed to change pressure at different intervals than other zones. In various example embodiments the pump itself may be programmable, and in other example embodiments the pump may be controlled by a remotely located program or control, such as by a smart phone or other such processing device. In various example embodiments the pump may be configured to operate on a standard 110 vac circuit such as those provided in most homes, nursing homes, or hospital environments. The device of the present general inventive concept may be referred to herein as a mattress topper, but in various example embodiments such a configuration may be integrated into another mattress.

Various example embodiments of the present general inventive concept may provide a mattress topper system including an upper sheet and a lower sheet coupled together so as to define an interior volume divided into a plurality of zones, each of the zones having a plurality of cells of which adjacent cells are in fluid communication with one another inside the respective zones, and at least one air pump configured to regulate pressure in the cells of each respective zone such that the pressure in at least a first one of the zones is different from the pressure in at least a second one of the zones. The at least one air pump may be configured to periodically change the pressure in the cells of each respective zone. The at least one air pump may be configured to maintain the pressure in the cells of each respective zone for a predetermined interval of time. The at least one air pump may be configured to regulate the pressure in the cells such that no two adjacent zones has the same pressure for the predetermined interval of time. The at least one air pump may be configured to raise or lower the pressure in the cells of each respective zone at predetermined intervals of time. The at least one air pump may be a multi-output configured with a plurality of air hoses respectively coupled to the respective zones. The at least one air pump may include a controller configured to control the at least one air pump to periodically adjust the pressure in the cells of the respective zones. The upper and lower sheets may be coupled together so as to form a plurality of zones in each of a lengthwise and lateral directions. The upper and lower sheets may be coupled together so as to form at least two zones in the lengthwise direction, and at least three zones in the lateral direction, such that six zones are formed having the plurality of cells in each of the six zones. The zones may have substantially same dimensions. The system may further include an equalization sheet provided over the upper sheet. The system may further include a foam layer provided over the upper sheet.

Various example embodiments of the present general inventive concept may provide a method of regulating pressure in a mattress topper to provide movement to a patient resting thereon, the method including providing a mattress topper that is partitioned into a plurality of zones in both lengthwise and lateral directions, each of the zones having a plurality of cells configured to be in fluid communication with one another inside those respective zones, providing at least one air pump to regulate pressure in the cells of each respective zone, and controlling the at least one air pump to periodically change the pressure in the respective zones at predetermined or random intervals of time. The periodically changing the pressure may include raising the pressure in at least a first one of the zones, and lowering the pressure in at least a second one of the zones. The periodically changing the pressure may include preventing any adjacent ones of the zones from having the same pressure during the intervals of time. The periodically changing the pressure may include changing the pressure in all of the zones at a same time. The intervals of time may be five, ten, or fifteen minutes. The periodically changing the pressure may include not repeating the pressure in any given zone for at least a predetermined number of the intervals of time. The periodically changing the pressure may include programming a range of pressures to be applied to each respective zone. The range of pressures may only include a maximum and minimum level of pressure.

Various example embodiments of the present general inventive concept may provide a mattress topper to provide movement to a patient resting thereon, the mattress topper including an upper sheet and a lower sheet coupled together so as to define an interior volume having a plurality of zones in both lengthwise and lateral directions, and a plurality of cells configured such that adjacent cells in each respective zone are in fluid communication with one another, and a fluid hose coupling provided to each respective zone.

Numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated.

It is noted that the simplified diagrams and drawings included in the present application do not illustrate all the various connections and assemblies of the various components, however, those skilled in the art will understand how to implement such connections and assemblies, based on the illustrated components, figures, and descriptions provided herein, using sound engineering judgment. Numerous variations, modification, and additional embodiments are possible, and, accordingly, all such variations, modifications, and embodiments are to be regarded as being within the spirit and scope of the present general inventive concept.

While the present general inventive concept has been illustrated by description of several example embodiments, and while the illustrative embodiments have been described in detail, it is not the intention of the applicant to restrict or in any way limit the scope of the general inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings. Additional modifications will readily appear to those skilled in the art. Accordingly, departures may be made from such details without departing from the spirit or scope of applicant's general inventive concept.

1. A mattress topper system comprising:
an upper sheet and a lower sheet coupled together so as to define an interior volume divided into a plurality of zones, each of the zones having a plurality of cells of which adjacent cells are in fluid communication with one another inside the respective zones; and
at least one air pump configured to regulate pressure in the cells of each respective zone such that the pressure in at least a first one of the zones is different from the pressure in at least a second one of the zones.

2. The system of claim 1, wherein the at least one air pump is configured to periodically change the pressure in the cells of each respective zone.

3. The system of claim 2, wherein the at least one air pump is configured to maintain the pressure in the cells of each respective zone for a predetermined interval of time.

4. The system of claim 3, wherein the at least one air pump is configured to regulate the pressure in the cells such that no two adjacent zones has the same pressure for the predetermined interval of time.

5. The system of claim 2, wherein the at least one air pump is configured to raise or lower the pressure in the cells of each respective zone at predetermined intervals of time.

6. The system of claim 1, wherein the at least one air pump is a multi-output configured with a plurality of air hoses respectively coupled to the respective zones.

7. The system of claim 1, wherein the at least one air pump comprises a controller configured to control the at least one air pump to periodically adjust the pressure in the cells of the respective zones.

8. The system of claim 1, wherein the upper and lower sheets are coupled together so as to form a plurality of zones in each of a lengthwise and lateral directions.

9. The system of claim 8, wherein the upper and lower sheets are coupled together so as to form at least two zones in the lengthwise direction, and at least three zones in the lateral direction, such that six zones are formed having the plurality of cells in each of the six zones.

10. The system of claim 1, wherein the zones have substantially same dimensions.

11. The system of claim 1, further comprising an equalization sheet provided over the upper sheet.

12. The system of claim 1, further comprising a foam layer provided over the upper sheet.

13. A method of regulating pressure in a mattress topper to provide movement to a patient resting thereon, the method comprising:
providing a mattress topper that is partitioned into a plurality of zones in both lengthwise and lateral directions, each of the zones having a plurality of cells configured to be in fluid communication with one another inside those respective zones;
providing at least one air pump to regulate pressure in the cells of each respective zone; and
controlling the at least one air pump to periodically change the pressure in the respective zones at predetermined or random intervals of time.

14. The method of claim 13, wherein the periodically changing the pressure comprises raising the pressure in at least a first one of the zones, and lowering the pressure in at least a second one of the zones.

15. The method of claim 13, wherein the periodically changing the pressure comprises preventing any adjacent ones of the zones from having the same pressure during the intervals of time.

16. The method of claim 13, wherein the periodically changing the pressure comprises changing the pressure in all of the zones at a same time.

17. The method of claim 13, wherein the intervals of time are five, ten, or fifteen minutes.

18. The method of claim 13, wherein the periodically changing the pressure comprises not repeating the pressure in any given zone for at least a predetermined number of the intervals of time.

19. The method of claim 13, wherein the periodically changing the pressure comprises programming a range of pressures to be applied to each respective zone.

20. A mattress topper to provide movement to a patient resting thereon, the mattress topper comprising:
an upper sheet and a lower sheet coupled together so as to define an interior volume comprising:
a plurality of zones in both lengthwise and lateral directions, and
a plurality of cells configured such that adjacent cells in each respective zone are in fluid communication with one another; and
a fluid hose coupling provided to each respective zone.
